(19) United States
(12) Patent Application Publication
(10) Pub. No.: US 2006/0013968 A1
(43) Pub. Date: Jan. 19, 2006

(54) Optical compensation film and manufacturing method thereof

(75) Inventors: Jen-Kwan Kuo, Ping Chen City (TW); Lung-Hai Wu, Ping Chen City (TW)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: OPTIMAX TECHNOLOGY CORPORATION, PING CHEN CITY (TW)

(21) Appl. No.: 10/963,632

(22) Filed: Oct. 14, 2004

(30) Foreign Application Priority Data
Jul. 13, 2004 (TW) 93120872

(51) Int. Cl. C09K 19/00; B29C 65/00

(52) U.S. Cl. 428/1.6; 156/60; 156/163; 156/212

(57) ABSTRACT

A substrate is pulled to a stretch ratio, and a liquid crystal material is then spread on a surface of the substrate to form a liquid crystal layer. Next, a protection layer is adhered onto the liquid crystal layer, thus forming an optical compensation film. The manufacturing of the optical compensation film uses substrate extension to replace a conventional alignment layer technique; the manufacturing efficiency and yield are therefore raised, and the manufacturing cost is reduced. Moreover, the arrangement uniformity of liquid crystal molecules is substantially improved, thus effectively enhancing the compensation and optical performance thereof.

### RELATED APPLICATIONS

The present application is based on, and claims priority from, Taiwan Application Serial Number 93120872, filed Jul. 13, 2004, the disclosure of which is hereby incorporated by reference herein in its entirety.

### BACKGROUND

1. Field of Invention

The present invention relates to a liquid crystal display panel. More particularly, the present invention relates to an optical compensation film and the manufacturing method thereof.

2. Description of Related Art

Liquid crystal display (LCD) has many advantages over other conventional types of displays including high display quality, small volume, light weight, low driving voltage and low power consumption. Hence, LCDs are widely used in small portable televisions, mobile telephones, video recording units, notebook computers, desktop monitors, projector televisions and so on, and have gradually replaced the conventional cathode ray tube (CRT) as a mainstream display unit. Therefore, the market is mainly occupied by LCDs due to the high display quality and the low power consumption of the LCDs. Large size, high resolution, wide view and rapid response time are the main demands on the LCDs.

Some popular wide view techniques have been developed, such as In-Plane Switching (IPS), Optical Compensated Birefringence (OCB), Multi-Domain Vertical Alignment (MVA), wide view optical compensation films and any combination thereof. The simplest one of these wide view techniques is to insert the wide view optical compensation films into a liquid crystal display panel, which increases the view-angle of the LCD to between about 140 and 160 degrees. This kind of wide view technique is available to liquid crystal displays in different sizes, and only involves insertion of the wide view optical compensation films into the LCD without changing the manufacturing processes thereof.

The prior art generally uses two main methods, such as electrical pulling and liquid crystal spreading, to manufacture conventional optical compensation films. FIG. 1A illustrates a flow chart of the traditional liquid crystal spreading method, and FIG. 1B illustrates a schematic view of the process of FIG. 1A. The following descriptions are made reference with FIG. 1A and FIG. 1B.

A substrate 111 is provided (step 101), and then an alignment layer 112 is spread on the substrate 111 by an alignment layer spreading device 122 (step 102). After being spread on the substrate 111, the alignment layer 122 is baked (step 103), aligned (step 104), and cleaned to remove residues thereon (step 105), thereby ensuring that liquid crystal molecules subsequently spread thereon are arranged in an orderly manner. The optical compensation film thus has a retardation value to compensate for view-angles and chromatic aberration.

As illustrated in FIG. 1B, the spread alignment layer 112 is baked by an alignment layer baking device 123, and is aligned and cleaned of residues by a mechanical roller alignment and residue cleaning device 124. After the foregoing steps, the surface of the alignment layer 112 has many slots generated by the rubbing of the mechanical roller. The slots are oriented in the same direction and are suitable for aligning liquid crystal molecules.

After that, a liquid crystal material having liquid crystal molecules is spread on the alignment layer 112 by a liquid crystal spreading device 126 to form a liquid crystal (LC) layer 116 (step 106). The liquid crystal molecules in the liquid crystal layer 112 are aligned to be oriented in the same direction by the slots. The liquid crystal layer 116 is baked to remove the solvent therein by a liquid crystal layer baking device 127 (step 107), and then is cured by a UV light device 128 (step 108).

Finally, protection layers 119 are separately adhered onto two sides of the substrate 111 having the alignment layer 112 and the liquid crystal layer 116 (step 109), and thus completing the conventional optical compensation film. FIG. 1C provides a schematic, cross-sectional view of the optical compensation film manufactured by the method in FIG. 1A. As illustrated in FIG. 1C, the optical compensation film 130 comprises the protection layer 119, the substrate 111, the alignment layer 112, the liquid crystal layer 116 and the other protection layer 119 in order.

However, the traditional method requires many prior steps, such as spreading the alignment layer and aligning the same by mechanical rubbing, for subsequently spreading the liquid crystal material. Therefore, under considerations of manufacturing efficiency, yields and cost, the traditional method is not ideal. Moreover, the slots of the alignment layer surface are generated by irregular mechanical damage, and therefore decrease the alignment uniformity of the liquid crystal molecules, and make enhancement of the compensation effect and optical performance of the optical compensation films difficult.

### SUMMARY

It is therefore an objective of the present invention to provide a method for manufacturing an optical compensation film, which uses substrate extension to replace a conventional alignment layer technique; the manufacturing efficiency and yield are thereby raised, and the cost is reduced.

It is another objective of the present invention to provide an optical compensation film, of which the uniformity of liquid crystal molecules is substantially improved, and thus effectively enhances the compensation and optical performance thereof.

In accordance with the foregoing and other objectives of the present invention, an optical compensation film and the manufacturing method thereof are provided. A substrate is pulled to a stretch ratio, and a liquid crystal material is then spread on a surface of the substrate to form a liquid crystal layer. Next, a protection layer is adhered onto the liquid crystal layer.

According to one preferred embodiment of the present invention, the method further comprises adhering a second protection layer onto a second surface of the substrate after pulling the substrate, spreading the liquid crystal material and then baking the liquid crystal layer and curing the liquid crystal layer by UV light. Moreover, the substrate is mechanically pulled to the stretch ratio by a pulling machine.

A material of the substrate is polyvinyl alcohol (PVA), triacetyl cellulose (TAC), ARTON, cyclic olefin copolymer (coc), cyclic olefin polymer (cop) or polyethylene terephthalate (PET). The liquid crystal material is nematic liquid crystal or discotic liquid crystal. When the material of the substrate is polyvinyl alcohol, the stretch ratio is between 5 and 12. In addition, materials of the first and second protection layers are triacetyl cellulose, cyclic olefin copolymer, cyclic olefin polymer or polyethylene terephthalate.

Compared with the conventional methods, the method of the present invention does not require the several prior steps, such as spreading the alignment layer, baking the alignment layer, aligning by mechanical rubbing and residue removal. Manufacturing efficiency and yields are thus increased, and the manufacturing cost is reduced. Moreover, the device for spreading the liquid crystal material can be placed behind the device for pulling the substrate; that is, the liquid crystal material can be spread immediately after the substrate is pulled. Therefore, the manufacturing processes are coherent and easily completed, in addition to proper maintenance of the stretch ratio of the substrate.

In another aspect, uniform and continuous striped slots are easily formed on the surface of the substrate, which are oriented in the pulling direction, because the substrate is pulled by skilled mechanical pulling with good uniformity. The uniform slots greatly help the uniform orientation of the polar liquid crystal molecules. In contrast to the conventional alignment layer with irregular slots formed by mechanical rubbing, the invention substantially improves the arrangement uniformity of liquid crystal molecules, and thus effectively enhances the compensation and optical performance of the optical compensation film.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A is a flow chart of the traditional liquid crystal spreading method;

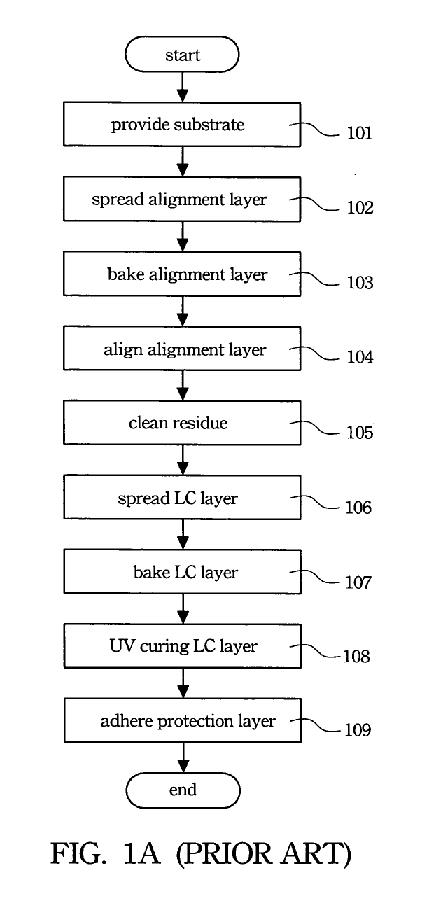

FIG. 1B is a schematic view of the process described in FIG. 1A;

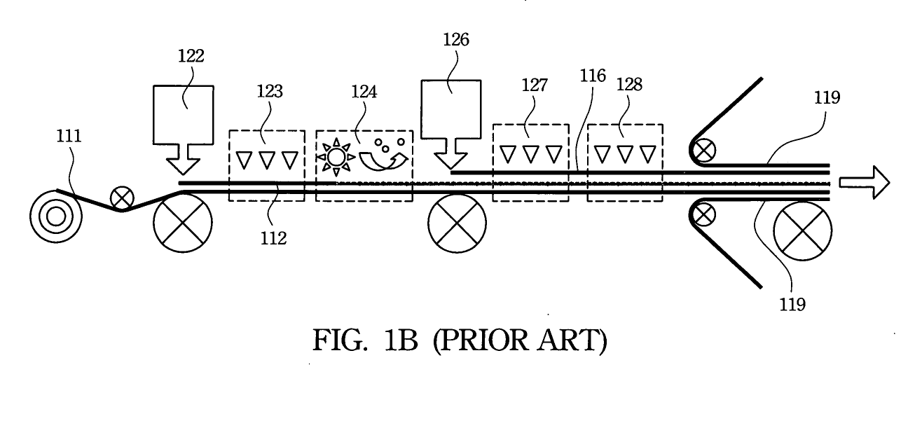

FIG. 1C is a schematic, cross-sectional view of the optical compensation film manufactured by the method described in FIG. 1A;

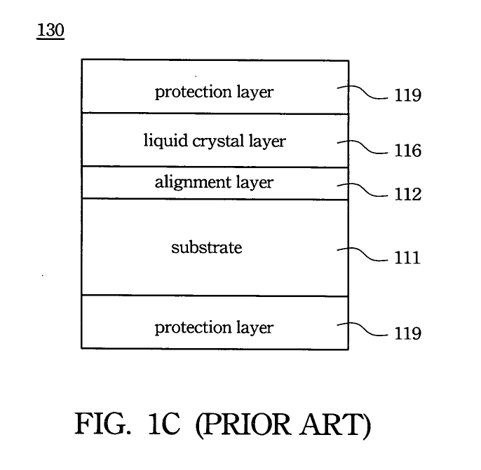

FIG. 2 is a flow chart of one preferred embodiment of the present invention;

FIG. 3A is a flow chart of another preferred embodiment of the present invention;

FIG. 3B is a schematic view of the process described in FIG. 3A; and

FIG. 3C is a schematic, cross-sectional view of an optical compensation film manufactured by the method described in FIG. 3A.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

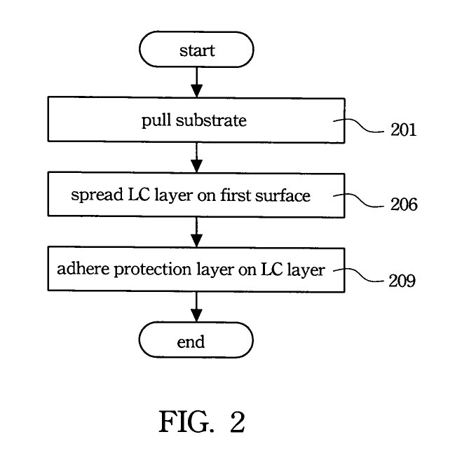

FIG. 2 is a flow chart of one preferred embodiment of the present invention. As illustrated in FIG. 2, a substrate is pulled to a stretch ratio (step 201), and a liquid crystal material is then spread on a surface of the substrate to form a liquid crystal layer (step 206). Next, a protection layer is adhered onto the liquid crystal layer (step 209).

A material of the substrate is polyvinyl alcohol (PVA), triacetyl cellulose (TAC), ARTON, cyclic olefin copolymer (coc), cyclic olefin polymer (cop) or polyethylene terephthalate (PET). The liquid crystal material is nematic liquid crystal or discotic liquid crystal; the nematic liquid crystal has a better compensation effect. A material of the protection layers is triacetyl cellulose, cyclic olefin copolymer, cyclic olefin polymer or polyethylene terephthalate.

In the preferred embodiment, according to different requirements and specifications, the optical compensation film can be made of various substrate materials, stretch ratios and liquid crystal materials to achieve the required compensation effect and obtain good optical performance.

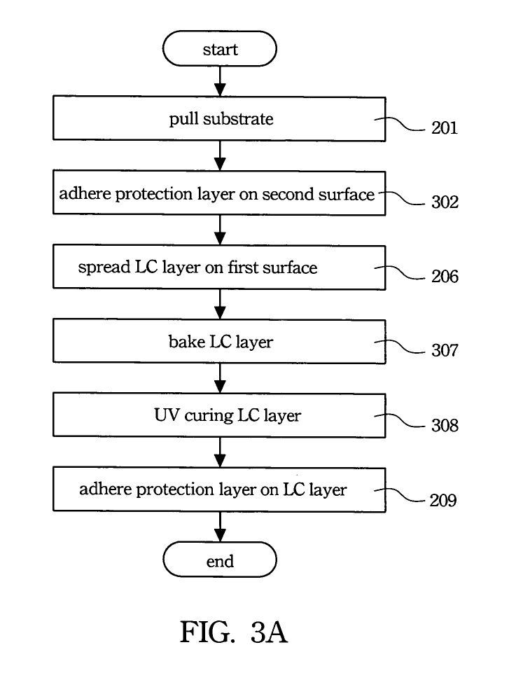

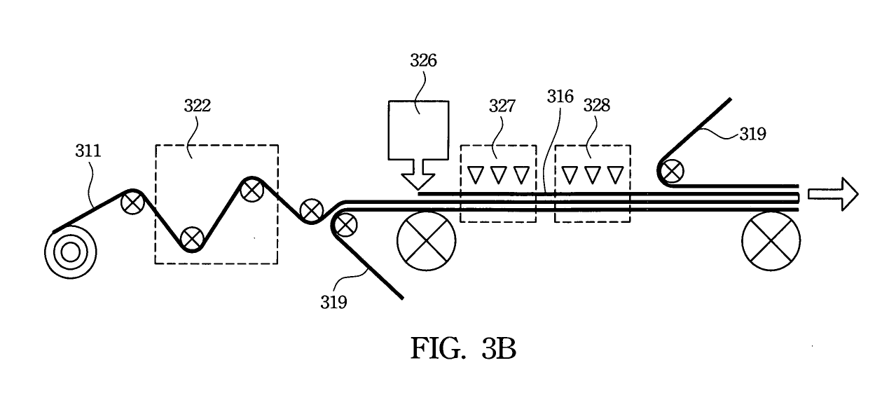

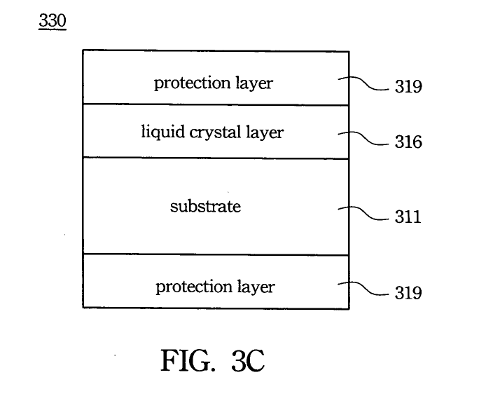

FIG. 3A is a flow chart of another preferred embodiment of the present invention, and FIG. 3B is a schematic view of a process in FIG. 3A. The following descriptions are made with reference to FIG. 3A and FIG. 3B.

A substrate 311 is pulled to a stretch ratio by a pulling device 322, such as a pulling machine (step 201). When the material of the substrate 311 is polyvinyl alcohol (PVA), the stretch ratio is between 5 and 12, and preferably is 10. A protection layer 319 is adhered onto the backside of the substrate 311 for protecting the pulled substrate 311 and giving enough supporting to prevent the substrate 311 from shrinking back (step 302).

A liquid crystal layer spreading device 326, such as a die, a wire bar, a gravure or other spreading device, is used to spread a liquid crystal material on the other surface of the substrate 311 to form a liquid crystal layer (step 206). In the preferred embodiment, the liquid crystal material comprises 25% BASF liquid crystal molecules, chiral dopant, photoinitiator and p-xylene, which is used as a solvent.

The chiral dopant cooperates with the liquid crystal molecules to form spiral structures, and the weight percent thereof is about 10%. Furthermore, according to other preferred embodiments of the present invention, the range of the weight percent of the liquid crystal molecules is between about 10% and 50%, depending on different types of liquid crystal and the required compensation effect.

After being pulled, the substrate 311 has uniform and continuous striped slots oriented in the pulling direction. The uniform slots substantially help the arrangement uniformity of polar liquid crystal molecules, such as the BASF liquid crystal molecules used in the preferred embodiment.

Therefore, the liquid crystal molecules in the liquid crystal layer 316 are aligned in the same direction by the slots. A liquid crystal layer baking device 327, such as an oven, is used to bake the liquid crystal layer 316 to remove the p-xylene solvent (step 307), and a UV light device 328 is used to cure the liquid crystal layer 316 (step 308). Finally, a protection layer 319 is adhered onto the liquid crystal layer 316 (step 209), thus completing the optical compensation film. FIG. 3C is a schematic, cross-sectional view of an optical compensation film manufactured by the method in FIG. 3A. As illustrated in FIG. 3C, the optical compensation film 330 comprises the protection layer 319, the substrate 311, the liquid crystal layer 316 and the other protection layer 319, in order.

In addition, a comparison of refractive indexes and retardations between a pulled PVA substrate with the stretch ratio of 10 and a pulled PVA substrate further with a BASF liquid crystal layer are listed in Table 1. In the embodiments in Table 1, a thickness of the cured liquid crystal layer 316 is about 1.3 mm, and the surface roughness thereof is about 5-6 nm. Nₓ is a refractive index in x direction, N_{y} is a refractive index in y direction, N_{z} is a refractive index in z direction, Ro is an in-plane retardation and Rₜₕ is an out-of-plane retardation.

TABLE 1
A comparison of refractive indexes and retardations between a
pulled PVA substrate and a pulled PVA substrate further with a BASE liquid
crystal layer.

| | Nₓ | N_{y} | N_{z} | R₀ | Rₜₕ |
|---|---|---|---|---|---|
| Pulled PVA substrate | 1.502-1.508 | 1.502-1.509 | 1.487-1.495 | 80-200 | 360-440 |
| Pulled PVA substrate/ | 1.503-1.508 | 1.502-1.511 | 1.486-1.496 | 100-220 | 310-500 |
| BASF liquid crystal layer | | | | | |

From Table 1, it is evident that the refractive indexes of the pulled PVA substrate with or without the BASF liquid crystal layer are almost unchanged. The range of in-phase retardation of the pulled PVA substrate with the BASF liquid crystal layer is not further changed more, either. However, the range of out-of-phase retardation of the pulled PVA substrate with the BASF liquid crystal layer is obviously greater than the range of out-of-phase retardation of the pulled PVA substrate without the BASF liquid crystal layer. The range of out-of-phase retardation is substantially increased from 80 to 210, and thus effectively enhances the compensation and optical performance of the optical compensation film.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for manufacturing an optical compensation film, comprising:
pulling a substrate to a stretch ratio;
spreading a liquid crystal material on a first surface of the substrate to form a liquid crystal layer; and
adhering a first protection layer onto the liquid crystal layer.

2. The method of claim 1, wherein the method further comprises:
adhering a second protection layer onto a second surface of the substrate after pulling the substrate.

3. The method of claim 2, wherein a material of the second protection layer is selected from a group consisting of triacetyl cellulose, cyclic olefin copolymer, cyclic olefin polymer and polyethylene terephthalate.

4. The method of claim 1, wherein the method further comprises:
baking the liquid crystal layer and curing the liquid crystal layer with UV light after spreading the liquid crystal material.

5. The method of claim 1, wherein the substrate is mechanically pulled by a pulling machine.

6. The method of claim 1, wherein a material of the substrate is selected from a group consisting of polyvinyl alcohol, triacetyl cellulose, ARTON, cyclic olefin copolymer, cyclic olefin polymer and polyethylene terephthalate.

7. The method of claim 1, wherein when a material of the substrate is polyvinyl alcohol, the stretch ratio is between about 5 and 12.

8. The method of claim 1, wherein the liquid crystal material is selected from a group consisting of nematic liquid crystal and discotic liquid crystal.

9. The method of claim 1, wherein a material of the first protection layer is selected from a group consisting of triacetyl cellulose, cyclic olefin copolymer, cyclic olefin polymer and polyethylene terephthalate.

10. An optical compensation film, comprising:
a substrate, having a stretch ratio;
a liquid crystal layer, on a first surface of the substrate; and
a first protection layer, on the liquid crystal layer.

11. The optical compensation film of claim 10, wherein a material of the substrate is selected from a group consisting of polyvinyl alcohol, triacetyl cellulose, ARTON, cyclic olefin copolymer, cyclic olefin polymer and polyethylene terephthalate.

12. The optical compensation film of claim 10, wherein when a material of the substrate is polyvinyl alcohol, the stretch ratio is between about 5 and 12.

13. The optical compensation film of claim 10, wherein a material of the liquid crystal layer is selected from a group consisting of nematic liquid crystal and discotic liquid crystal.

14. The optical compensation film of claim 10, wherein a material of the first protection layer is selected from a group consisting of triacetyl cellulose, cyclic olefin copolymer, cyclic olefin polymer and polyethylene terephthalate.

15. The optical compensation film of claim 10, wherein the optical compensation film further comprises:
a second protection layer, on a second surface of the substrate.

16. The optical compensation film of claim 15, wherein a material of the second protection layer is selected from a group consisting of triacetyl cellulose, cyclic olefin copolymer, cyclic olefin polymer and polyethylene terephthalate.
